(19) United States
(12) Patent Application Publication
(10) Pub. No.: US 2022/0206487 A1
(43) Pub. Date: Jun. 30, 2022

(54) METHOD FOR MAINTAINING PREDICTIVE VALUE OF DEVICE THROUGH CONTROL OUTPUT SIGNAL

(71) Applicant: ITS CO., LTD., Ulsan (KR)

(72) Inventor: Young Kyu Lee, Ulsan (KR)

(21) Appl. No.: 17/611,490

(22) PCT Filed: Jun. 4, 2020
(86) PCT No.: PCT/KR2020/007280

§ 371 Date: Nov. 15, 2021

(30) Foreign Application Priority Data
Jun. 25, 2019 (KR) 10-2019-0075815

(51) Int. Cl. G05B 23/02; G05B 19/418

(52) U.S. Cl. CPC G05B 23/0283; G05B 23/0224; G05B 19/4184

(57) ABSTRACT

The present invention relates to a method for maintaining a predictive value of a device through a control output signal, and there is an effect that operating information of a device in a normal state and operating information of a device shown before a malfunction occurs are collected, a distrust value is set based on the collected information, a collection value depending on operating information of the device collected in real time is compared with the distrust value, and a warning is given when a condition that an abnormal symptom of the device is doubted is satisfied to guide repairing and replacement of the device to be performed at an appropriate time, thereby preventing enormous loss of money due to the malfunction of the device in advance.

### CROSS-REFERENCE TO RELATED APPLICATIONS

This application is the National Stage filing under 35 U.S.C. 371 of International Application No. PCT/KR2020/007280, filed on Jun. 4, 2020, which claims the benefit of K.R application No. 10-2019-0075815, filed on Jun. 25, 2019, the contents of which are all hereby incorporated by reference herein in their entirety.

### BACKGROUND

The present invention relates to a method for maintaining a predictive value of a device through a control output signal, and more particularly, to a method for maintaining a predictive value of a device through a control output signal, which collects operating information of a device in a normal state and operating information of a device shown before a malfunction occurs, sets a distrust value based on the collected information, compares a collection value depending on operating information of the device collected in real time with the distrust value, and gives a warning when a condition that an abnormal symptom of the device is doubted is satisfied to guide repairing and replacement of the device to be performed at an appropriate time, thereby preventing enormous loss of money due to the malfunction of the device in advance.

In general, in the case of various devices used for an automated process of a facility, a stable operation is very important.

For example, tens or hundreds of devices are installed in the facilities of a large-scale production plant to continuously produce products while interlocking with each other. If any one of a plurality of devices has a malfunction, an enormous situation may occur in which an operation of the facility is stopped as a whole.

At this time, due to the occurrence of downtime due to the malfunction of the device, a huge loss caused by not only the repair cost of the device, but also operating costs wasted while the facility is stopped and business effects.

According to recent data from the Ministry of Employment and Labor and the Korea Occupational Safety and Management Agency, casualties caused by the annual industrial safety accidents were collected at a total of 100,000, and a loss of 18 trillion won annually occurs when converting the casualties into cost.

As a method for avoiding such unexpected downtime costs, it is urgent to introduce a predictive maintenance system. There are efforts to improve the problem under the name of predictive maintenance, but it is necessary to develop higher predictive maintenance methods for more efficient predictive maintenance.

The present invention is proposed to solve all problems described above, and an object of the present invention is to provide a method for maintaining a predictive value of a device through a control output signal, which collects operating information of a device in a normal state and operating information of a device shown before a malfunction occurs, sets a distrust value based on the collected information, compares a collection value depending on operating information of the device collected in real time with the distrust value, and gives a warning when a condition that an abnormal symptom of the device is doubted is satisfied to guide repairing and replacement of the device to be performed at an appropriate time, thereby preventing enormous loss of money due to the malfunction of the device in advance.

Further, another object of the present invention is to provide a method for maintaining a predictive value of a device through a control output signal, which presents various detection conditions to search for an abnormal symptom which occurs in the device and detects the device in an abnormal state when the detection condition is satisfied to very precisely and effectively detect the abnormal symptom which occurs in the device and securing excellent reliability for a detection result.

### SUMMARY

In order to achieve the object, a method for maintaining a predictive value of a device through a control output signal according to the present invention includes: a first base information collecting step (S10) is a step of measuring and collecting a time required from a time when an operation of a device which operates by receiving a control output signal output from a control unit in a normal state starts up to a time when the operation ends; a second base information collecting step (S20) of measuring and collecting a time required from a time when an operation of a device which operates by receiving a control output signal output from a control unit before a malfunction occurs starts up to a time when the operation ends; a setting step (S30) of setting a first distrust value for the time required for the operation based on time information collected in the first and second base information collecting steps (S10 and S20); and a detection step (S40) of measuring and collecting a time required from a time when the device which operates by receiving the control output signal output by the control unit so that the operation of the device is performed in real time starts up to a time when the operation ends, and detecting the device as the abnormal state when the collected time value exceeds the first distrust value.

Further, in the first and second base information collecting steps (S10 and S20), a time interval between a control output signal repeatedly output by the control unit so as to repeatedly perform the operation of the device, and a next control output signal is further measured and collected, in the setting step (S30), a second distrust value for the time interval between the control output signal, and the next control output signal is set based on the time interval information collected in the first and second base information collecting steps (S10 and S20), and in the detection step (S40), the time interval between the control output signal output by the control unit so that the operation of the device is repeatedly performed in real time, and the next control signal is measured and collected, and when the collected time interval value exceeds the second distrust value, the device is detected as the abnormal state.

Further, the first, second distrust value is set separately into the warning value and the risk value like the first distrust value, but the warning value is set to a value smaller than the risk value, in the detection step (S40), when the time value and the time interval value collected by the device in real time exceed the warning values of the first and second distrust values, respectively, the device is recognized as a warning state, and when the time value and the time interval value collected by the device in real time exceed the risk values of the first and second distrust values, respectively, the device is recognized as a risk state at a higher level of a malfunction risk level of the device than the warning state.

Further, in the setting step (S30), a risk detection interval of a predetermined time including the operation of the device twice or more is set, and the number of times at which the time value of the device or the time interval value of the device or the time value and the time interval value in the risk detection interval set in the detection step (S40) exceed the warning values of the first and second distrust values is counted, but when the counted number of times set in the setting step (S30) is detected to exceed the number of times set in the setting step (S30), the device is recognized as the risk state.

Further, in the setting step (S30), time information capable of using the device is input, and in the detection step (S40), an average use time of the device for one day or a predetermined period is extracted and a use period during the device may be used at a current time is detected and provided based on the extracted average use time information.

Further, instead of measuring and collecting the time interval between the control output signal repeatedly output by the control unit and the next control output signal in the first and second base information collecting steps (S10 and S20), the time interval from the time when one operation of the device starts up to the a time when one next operation starts is measured and collected, in the setting step (S30), when a third distrust value for a time interval from the time when one operation of the device starts up to the time when one next operation starts based on the time interval information collected in the first and second base information collecting steps (S10 and S20) is set, and in the detection step (S40), a time interval from the time when one operation of the device which repeatedly operates based on the control output signal output by the control unit in real time up to the time when one next operation starts is measured and collected, and when the collected time interval value exceeds the third distrust value, the device is detected as the abnormal state.

As described above, according to the method for maintaining a predictive value of a device through a control output signal, there is an effect that operating information of a device in a normal state and operating information of a device shown before a malfunction occurs are collected, a distrust value is set based on the collected information, a collection value depending on operating information of the device collected in real time is compared with the distrust value, and a warning is given when a condition that an abnormal symptom of the device is doubted is satisfied to guide repairing and replacement of the device to be performed at an appropriate time, thereby preventing enormous loss of money due to the malfunction of the device in advance.

Further, there is an effect that various detection conditions are presented to search for an abnormal symptom which occurs in the device and the device in an abnormal state is detected when the detection condition is satisfied to very precisely and effectively detect the abnormal symptom which occurs in the device and securing excellent reliability for a detection result.

### DESCRIPTION OF THE DRAWINGS

FIG. 1 is a block diagram of a method for maintaining a predictive value of a device of a control output signal according to an embodiment of the present invention.

FIG. 2 is a diagram illustrating a first base information collecting step according to an embodiment of the present invention.

FIG. 3 is a diagram illustrating a second base information collecting step according to an embodiment of the present invention.

FIG. 4 is a diagram illustrating a detection step according to an embodiment of the present invention.

FIG. 5 is a diagram illustrating first and second base information collecting steps according to an embodiment of the present invention.

FIG. 6 is a diagram illustrating first and second base information collecting steps according to an embodiment of the present invention.

FIG. 7 is a diagram illustrating a state detection method of a device based on a second distrust value according to an embodiment of the present invention.

FIG. 8 is a diagram illustrating a process of detecting a state of a device through a risk detection interval based on a time value required for an operation of the device according to an embodiment of the present invention.

FIG. 9 is a diagram illustrating a process of detecting a state of a device through a risk detection interval based on a time interval value between a time value required for an operation of the device and a control output signal output by a control unit according to an embodiment of the present invention.

FIG. 10 is a diagram illustrating first and second base information collecting steps according to an embodiment of the present invention.

FIG. 11 is a diagram illustrating a state detection method of a device based on a third distrust value according to an embodiment of the present invention.

### DETAILED DESCRIPTION

Technology described below may have various modifications and various embodiments and specific embodiments will be illustrated in the drawings and described in detail. However, this does not limit the technology described below to specific embodiments, and it should be understood that the technology described below covers all the modifications, equivalents and replacements included within the idea and technical scope of the present disclosure.

Terms including as first, second, A, B, and the like are used for describing various constituent elements, but the constituent elements are not limited by the terms and the terms are used only for distinguishing one constituent element from other constituent elements. For example, a first component may be referred to as a second component, and similarly, the second component may be referred to as the first component without departing from the scope of the technology to be described below. A term ‘and/or’ includes a combination of a plurality of associated disclosed items or any item of the plurality of associated disclosed items. For example, ‘A and/or B’ may be construed as ‘at least one of A and B.’

It is to be understood that the singular expression encompass a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

Prior to a detailed description for drawings, it will be apparent that classifying components in the present specification is just classifying the components for each main function which each component takes charge of. That is, two or more components to be described below may be combined into one component or one component may be divided into two or more for each more subdivided function, and provided. In addition, each of the components to be described below may additionally perform some or all of the functions that are handled by other components in addition to main functions that the corresponding component is responsible for, and some of the main functions of which the respective components take charge may be exclusively carried out by other components.

Further, in performing a method or an operating method, respective processes constituting the method may be performed differently from a described order unless a specific order is not disclosed clearly in terms of a context. That is, the respective processes may be performed similarly to the specified order, performed substantially simultaneously, and performed in an opposite order.

A method for maintaining a predictive value of a device through a control output signal according to a preferred embodiment of the present invention will be described in detail with reference to the accompanying drawings. The detailed description of publicly-known function and configuration that may make the gist of the present invention unnecessarily ambiguous will be omitted.

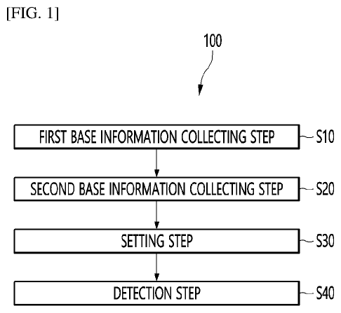

FIG. 1 is a block diagram of a method for maintaining a predictive value of a device of a control output signal according to an embodiment of the present invention.

As illustrated in FIG. 1, the method for maintaining a predictive value of a device through a control output signal according to an embodiment of the present invention includes a first base information collecting step (S10), a second base information collecting step (S20), a setting step (S30), and a detecting step (S40).

The first base information collecting step (S10) is a step of measuring and collecting a time required from a time when an operation of a device which operates by receiving a control output signal output from a control unit in a normal state starts up to a time when the operation ends.

Here, for the convenience of description, an energy (power) value consumed while the device performs one operation is illustrated as a waveform according to a flow of the time, and the time required for one operation of the device is measured and collected by setting a time when the energy value in the waveform increases to a predetermined value which is arbitrarily set as a time when the operation starts and setting a time when the energy value decreases to the predetermined value or less as a time when the operation ends, but it is not of course that the time required for the operation of the device is measured only by such a scheme.

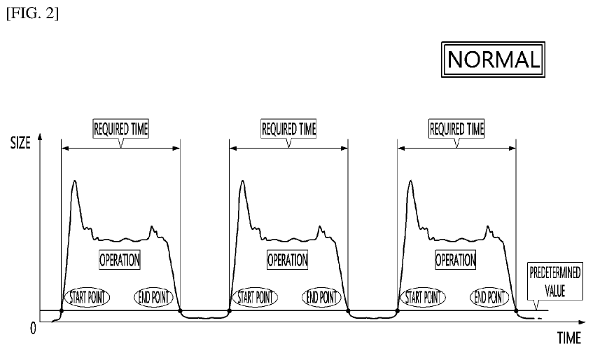

FIG. 2 is a diagram illustrating a first base information collecting step according to an embodiment of the present invention. In particular, FIG. 2 is a diagram illustrating a process of detecting a time required for an operation of a drilling machine repeatedly performing an operation of consecutively drilling a hole in a normal state according to an embodiment of the present invention.

Time values for the operation of the device which are collected and extracted in the first base information collecting step (S10) become a basis of a first distrust value set for detecting an abnormal symptom of the device in the setting step (S30) to be described below.

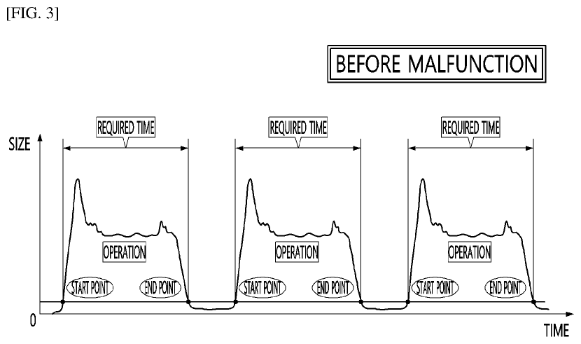

FIG. 3 is a diagram illustrating a second base information collecting step according to an embodiment of the present invention.

As illustrated in FIG. 3, the second base information collecting step (S20) is a step of measuring and collecting a time required from a time when an operation of a device which operates by receiving a control output signal output from a control unit before a malfunction occurs starts up to a time when the operation ends.

It is of course that time values for the operation of the device which are collected and extracted in the second base information collecting step (S20) become a basis of a first distrust value set for detecting an abnormal symptom of the device in the setting step (S30), along with the time values collected in the first base information collecting step (S10).

Here, it may be known that the time required for the operation of the device illustrated in FIG. 3 is longer than the time required for the operation of the device illustrated in FIG. 2, and this may cause guessing that the time required for the operation performed by the device gradually increases as the state of the device is poor.

The setting step (S30) is a step of setting a first distrust value for the time required for the operation based on time information collected in the first and second base information collecting steps (S10 and S20).

Here, the first distrust value is set based on values in which a time value is abnormally changed (increased) before the malfunction of the device occurs based on the time information collected for a long time in the first and second base information collecting steps (S10 and S20).

The first distrust value of the method 100 for maintaining a predictive value of a device through a control output signal according to the present invention is set separately as a warning value and a risk value, but it is not of course that the first distrust value is described by limiting to such a value.

Here, the warning value is set to a value smaller than the risk value, and the warning and risk values will be described in detail in the detection step (S40) to be described below.

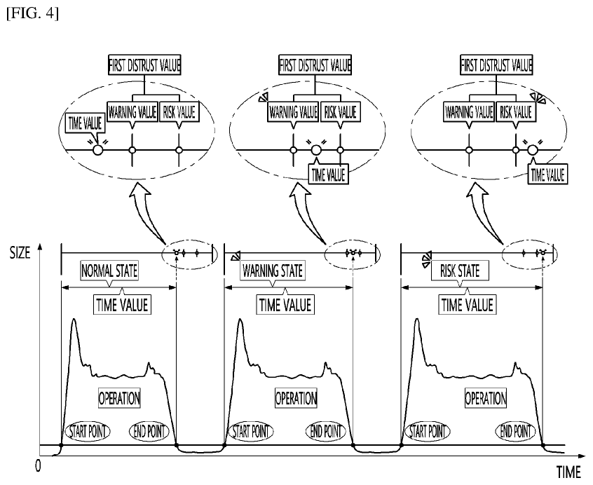

FIG. 4 is a diagram illustrating a detection step according to an embodiment of the present invention.

The detection step (S40) is a step of measuring and collecting a time required from a time when the device which operates by receiving the control output signal output by the control unit so that the operation of the device is performed in real time starts up to a time when the operation ends, and detecting the device as the abnormal state when the collected time value exceeds the first distrust value.

Referring to FIG. 4, when the time value required for the operation of the device in real time does not exceed a warning value or a risk value of the first distrust value, the device is detected as the normal state, when the time value required for the operation of the device exceeds the warning value, the device is detected as a warning state, and when the time value required for the operation of the device exceeds the risk value, the device is detected as a risk state.

Here, the warning value indicates a malfunction risk level of a lower level than the risk value, and the warning state of the device is a degree at which an interest and a caution of the device are requested, and the risk state of the device may be regarded as a degree at which repairing, checking, or replacement of the device is requested.

Accordingly, the abnormal symptom is detected in advance based on the state of the device detected in real time in the detection step (S40) to guide economical loss which may occur due to a stop of an overall operation of the facility due to a sudden malfunction of the device from being prevented in advance.

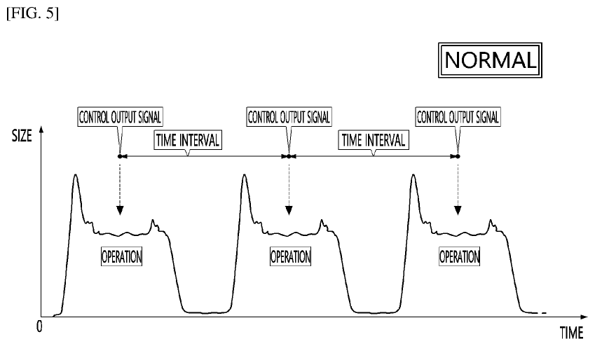

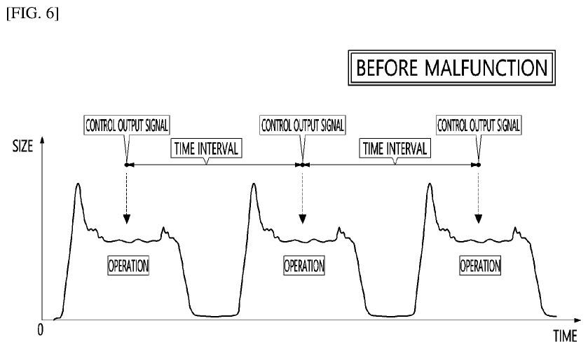

FIGS. 5 and 6 are diagrams illustrating first and second base information collecting steps according to an embodiment of the present invention.

As illustrated in FIGS. 5 and 6, in the first and second base information collecting steps (S10 and S20), a time interval between a control output signal repeatedly output by the control unit so as to repeatedly perform the operation of the device, and a next control output signal is further measured and collected, in the setting step (S30), a second distrust value for the time interval between the control output signal, and the next control output signal is set based on the time interval information collected in the first and second base information collecting steps (S10 and S20), and in the detection step (S40), the time interval between the control output signal output by the control unit so that the operation of the device is repeatedly performed in real time, and the next control signal is measured and collected, and when the collected time interval value exceeds the second distrust value, the device is detected as the abnormal state.

Here, the second distrust value is set separately into the warning value and the risk value like the first distrust value, and in this case, the warning value is set to a value smaller than the risk value.

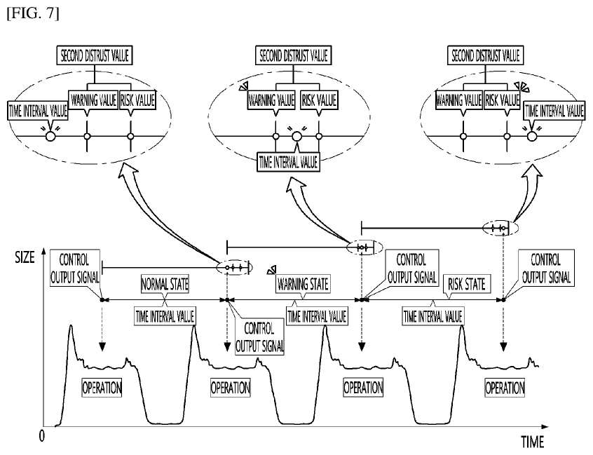

FIG. 7 is a diagram illustrating a state detection method of a device based on a second distrust value according to an embodiment of the present invention.

As illustrated in FIG. 7, when a time interval value between a control output signal output by the control unit to command the operation of the device in real time, and the next control output signal does not exceeds the warning and risk values of the second distrust value, the device is detected as the normal state, when the time interval value exceeds the warning value, the device is detected as the warning state, and when the time interval value exceeds the risk value, the device is detected as the risk state.

Here, the warning value indicates a malfunction risk level of a lower level than the risk value, and the warning state of the device is a degree at which an interest and a caution of the device are requested, and the risk state of the device may be regarded as a degree at which repairing, checking, or replacement of the device is requested.

Accordingly, the abnormal symptom is detected in advance based on the state of the device detected in real time in the detection step (S40) to guide economical loss which may occur due to a stop of an overall operation of the facility due to a sudden malfunction of the device from being prevented in advance.

Meanwhile, in the setting step (S30), a risk detection interval of a predetermined time including the operation of the device twice or more is set, and the number of times at which the time value required for the operation of the device in the risk detection interval, the time interval value between the control output signals, and the time interval value between the control output signals set in the detection step (S40) exceed the warning values of the first and second distrust values is counted, but when the counted number of times set in the setting step (S30) is detected to exceed the number of times set in the setting step (S30), the device is recognized as the risk state.

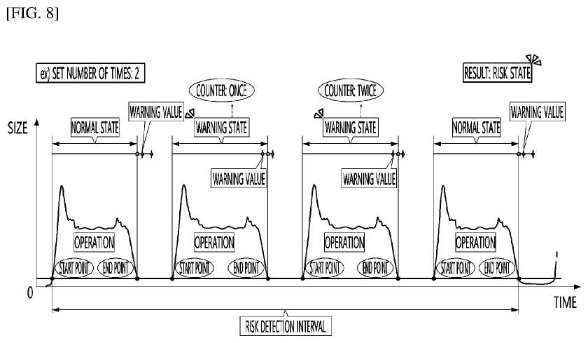

FIG. 8 is a diagram illustrating a process of detecting a state of a device through a risk detection interval based on a time value required for an operation of the device according to an embodiment of the present invention.

Referring to FIG. 8, in the setting step (S30), an interval including four operations of the device is set as the risk detection interval, and when the set number of times is set to two, when the time value required for operation of the device is real time in the risk detection interval in the detection step (S40) exceeds the warning value of the first distrust value, the number of times is counted, but when the counted number of times is set to two or more set in the setting step (S30), the device is recognized as the risk state to guide predictive value maintenance through precise checking or replacement of the device.

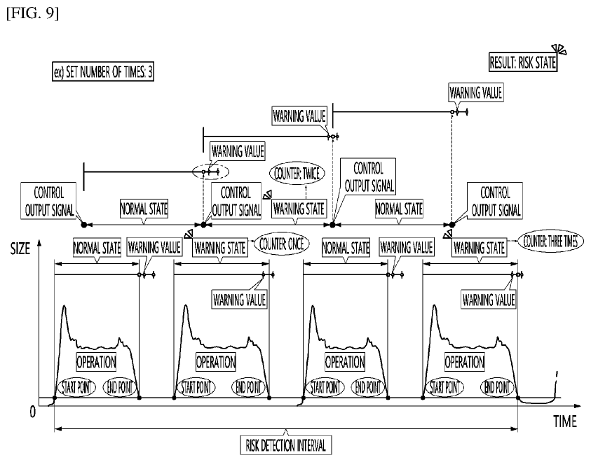

FIG. 9 is a diagram illustrating a process of detecting a state of a device through a risk detection interval based on a time interval value between a time value required for an operation of the device and a control output signal output by a control unit according to an embodiment of the present invention.

Referring to FIG. 9, in the setting step (S30), an interval including four operations of the device is set as the risk detection interval, and when the set number of times is set to three, when the time value required for operation of the device is real time in the risk detection interval in the detection step (S40) exceeds the warning value of the first distrust value, the number of times is counted and when the time interval value between the control output signals output by the control unit exceeds the warning value of the second distrust value, the number of times is counted, but when the counted number of times is set to three or more set in the setting step (S30), the device is recognized as the risk state to guide predictive value maintenance through precise checking or replacement of the device.

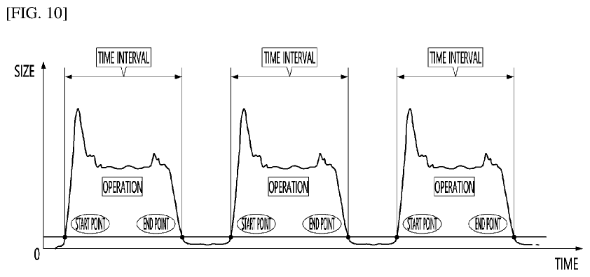

FIG. 10 is a diagram illustrating first and second base information collecting steps according to an embodiment of the present invention.

As illustrated in FIG. 10, instead of measuring and collecting the time interval between the control output signal repeatedly output by the control unit and the next control output signal in the first and second base information collecting steps (S10 and S20), the time interval from the time when one operation of the device starts up to the a time when one next operation starts is measured and collected, in the setting step (S30), when a third distrust value for a time interval from the time when one operation of the device starts up to the time when one next operation starts based on the time interval information collected in the first and second base information collecting steps (S10 and S20) is set, and in the detection step (S40), a time interval from the time when one operation of the device which repeatedly operates based on the control output signal output by the control unit in real time up to the time when one next operation starts is measured and collected, and when the collected time interval value exceeds the third distrust value, the device is detected as the abnormal state.

Here, the third distrust value is set separately into the warning value and the risk value like the first and second distrust values, and in this case, the warning value is set to a value smaller than the risk value.

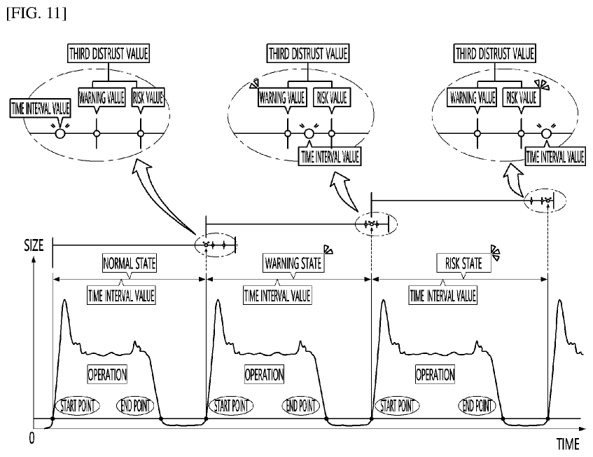

FIG. 11 is a diagram illustrating a state detection method of a device based on a third distrust value according to an embodiment of the present invention.

As illustrated in FIG. 11, when the time interval value between the time when the operation of the device starts in real time and the time when the next operation starts does not exceeds the warning and risk values of the third distrust value, the device is detected as the normal state, when the time interval value exceeds the warning value, the device is detected as the warning state, and when the time interval value exceeds the risk value, the device is detected as the risk state.

Accordingly, the abnormal symptom is detected in advance based on the state of the device detected in real time in the detection step (S40) to guide economical loss which may occur due to a stop of an overall operation of the facility due to a sudden malfunction of the device from being prevented.

Meanwhile, in the setting step (S30), time information capable of using the device is input and set, and in the detection step (S40), an average use time of the device for one day or a predetermined period is extracted and a use period during the device may be used at a current time is detected and provided based on the extracted average use time information.

In general, the device has an average use life-span, and when the average use life-span is converted into the time and set in the setting step (S30), since an average usage amount of the device may be measured and a period (time) when the device may be used may be detected and provided to a manager, the manager may clearly recognize a substantial use life-span of the device to efficiently design a long plan for replacement of the device, etc., thereby guiding the facility to be stably operated and managed.

According to the method 100 for maintaining a predictive value of a device through a control output signal, which detects the abnormal symptom of the device by such a process, there is an effect that operating information of a device in a normal state and operating information of a device shown before a malfunction occurs are collected, a distrust value is set based on the collected information, a collection value depending on operating information of the device collected in real time is compared with the distrust value, and a warning is given when a condition that an abnormal symptom of the device is doubted is satisfied to guide repairing and replacement of the device to be performed at an appropriate time, thereby preventing enormous loss of money due to the malfunction of the device in advance.

Further, there is an effect that various detection conditions are presented to search for an abnormal symptom which occurs in the device and the device in an abnormal state is detected when the detection condition is satisfied to precisely and effectively detect the abnormal symptom which occurs in the device and securing excellent reliability for a detection result.

The method 100 for maintaining a predictive value of a device through a control output signal according to the present invention is described based on the control output signal output to the device by the control unit, but even though the technology is applied based on a control input signal output from the control unit and input into the device, it is of course that the same effect may be expected.

The present invention has bee described with reference to the embodiment illustrated in the accompanying drawings and is just exemplary and is not limited to the above-described embodiments, but this is just exemplary, and it will be appreciated by those skilled in the art that various modifications and embodiments equivalent thereto can be made therefrom. In addition, modifications by those skilled in the art can be made without departing from the scope of the present invention. Therefore, the scope of the claims in the present invention will not be defined within the scope of the detailed description but will be defined by the following claims and the technical spirit thereof.

The embodiments of the present disclosure may be implemented by various means, for example, hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Further, in the case of implementation by firmware or software, the embodiment of the present invention may be implemented in the form of a module, a procedure, a function, and the like to perform the functions or operations described above and recorded in recording media readable by various computer means. Herein, the recording medium may include singly a program command, a data file, or a data structure or a combination thereof. The program command recorded in the recording medium may be specially designed and configured for the present invention or may be publicly known to and used by those skilled in the computer software field. Examples of the computer-readable recording medium include magnetic media such as a hard disk, a floppy disk, and a magnetic tape, optical media such as a CD-ROM (compact disk read only memory) and a DVD (digital video disk), magneto-optical media such as a floptical disk, and a hardware device which is specifically configured to store and execute the program command such as a ROM, a RAM, and a flash memory. An example of the program command includes a high-level language code executable by a computer by using an interpreter and the like, as well as a machine language code created by a compiler. The hardware devices may be configured to operate as one or more software modules in order to perform the operation of the present invention, and an opposite situation thereof is available.

In addition, an apparatus or terminal according to the present invention may be driven by commands that cause one or more processors to perform the functions and processes described above. The commands may include, for example, interpreted commands such as script commands, such as JavaScript or ECMAScript commands, executable codes or other commands stored in computer readable media. Further, the apparatus according to the present invention may be implemented in a distributed manner across a network, such as a server farm, or may be implemented in a single computer device.

In addition, a computer program (also known as a program, software, software application, script or code) that is embedded in the apparatus according to the present invention and which implements the method according to the present invention may be prepared in any format of a compiled or interpreted language or a programming language including a priori or procedural language and may be deployed in any format including standalone programs or modules, components, subroutines, or other units suitable for use in a computer environment. The computer program does not particularly correspond to a file in a file system. The program may be stored in a single file provided to a requested program, in multiple interactive files (e.g., a file storing one or more modules, subprograms, or portions of code), or in a part (e.g., one or more scripts stored in a markup language document) of a file storing another program or data. The computer program may be positioned in one site or distributed throughout a plurality of sites and extended to be executed on multiple computers interconnected by a communication network or one computer.

Although the drawings have been described separately for the sake of convenience of explanation, it is also possible to design a new embodiment to be implemented by merging the embodiments described in each drawing. Further, configurations and methods of the described embodiments may not be limitedly applied to the aforementioned present invention, but all or some of the respective embodiments may be selectively combined and configured so as to be variously modified.

Further, while the preferred embodiments of the present invention have been illustrated and described above, the present invention is not limited to the aforementioned specific embodiments, various modifications may be made by a person with ordinary skill in the technical field to which the present invention pertains without departing from the subject matters of the present invention that are claimed in the claims, and these modifications should not be appreciated individually from the technical spirit or prospect of the present invention.

The present invention may be applied to various device inspection technical fields.

I/We claim:

1. A method for maintaining a predictive value of a device through a control output signal, the method comprising:
a first base information collecting step is a step of measuring and collecting a time required from a time when an operation of a device which operates by receiving a control output signal output from a control unit in a normal state starts up to a time when the operation ends;
a second base information collecting step of measuring and collecting a time required from a time when an operation of a device which operates by receiving a control output signal output from a control unit before a malfunction occurs starts up to a time when the operation ends;
a setting step of setting a first distrust value for the time required for the operation based on time information collected in the first and second base information collecting steps; and
a detection step of measuring and collecting a time required from a time when the device which operates by receiving the control output signal output by the control unit so that the operation of the device is performed in real time starts up to a time when the operation ends and detecting the device as an abnormal state when the collected time value exceeds the first distrust value.

2. The method for maintaining a predictive value of a device through a control output signal of claim 1, wherein in the first and second base information collecting steps, a time interval between a control output signal repeatedly output by the control unit so as to repeatedly perform the operation of the device, and a next control output signal is further measured and collected,
in the setting step, a second distrust value for the time interval between the control output signal, and the next control output signal is set based on the time interval information collected in the first and second base information collecting steps, and
in the detection step, the time interval between the control output signal output by the control unit so that the operation of the device is repeatedly performed in real time, and the next control signal is measured and collected, and when the collected time interval value exceeds the second distrust value, the device is detected as the abnormal state.

3. The method for maintaining a predictive value of a device through a control output signal of claim 2, wherein the first and second distrust value is set separately into the warning value and the risk value like the first distrust value, but the warning value is set to a value smaller than the risk value,
in the detection step, when the time value and the time interval value collected by the device in real time exceed the warning values of the first and second distrust values, respectively, the device is recognized as a warning state, and
when the time value and the time interval value collected by the device in real time exceed the risk values of the first and second distrust values, respectively, the device is recognized as a risk state at a higher level of a malfunction risk level of the device than the warning state.

4. The method for maintaining a predictive value of a device through a control output signal of claim 3, wherein in the setting step, a risk detection interval of a predetermined time including the operation of the device twice or more is set, and
the number of times at which the time value of the device or the time interval value of the device and the time value and the time interval value in the risk detection interval set in the detection step exceed the warning values of the first and second distrust values is counted, but when the counted number of times set in the setting step is detected to exceed the number of times set in the setting step, the device is recognized as the risk state.

5. The method for maintaining a predictive value of a device through a control output signal of claim 4,
wherein in the setting step, time information capable of using the device is input, and
wherein in the detection step, an average use time of the device for one day or a predetermined period is extracted and a use period during the device may be used at a current time is detected and provided based on the extracted average use time information.

6. The method for maintaining a predictive value of a device through a control output signal of claim 2, wherein instead of measuring and collecting the time interval between the control output signal repeatedly output by the control unit and the next control output signal in the first and second base information collecting steps, the time interval from the time when one operation of the device starts up to the a time when one next operation starts is measured and collected,
in the setting step, when a third distrust value for a time interval from the time when one operation of the device starts up to the time when one next operation starts based on the time interval information collected in the first and second base information collecting steps is set, and
in the detection step, a time interval from the time when one operation of the device which repeatedly operates based on the control output signal output by the control unit in real time up to the time when one next operation starts is measured and collected, and when the collected time interval value exceeds the third distrust value, the device is detected as the abnormal state.
